(19) United States
(12) Patent Application Publication
(10) Pub. No.: US 2009/0109205 A1
(43) Pub. Date: Apr. 30, 2009

(54) MONITORING AND SETTING APPARATUS AND PRODUCTION SYSTEM INCLUDING THE SAME

(76) Inventor: Takeshi MUTOH, Nara (JP)

Correspondence Address: NIXON & VANDERHYE, PC, 901 NORTH GLEBE ROAD, 11TH FLOOR, ARLINGTON, VA, 22203, US

(21) Appl. No.: 12/259,542

(22) Filed: Oct. 28, 2008

(30) Foreign Application Priority Data
Oct. 29, 2007 (JP) 2007-280494

(51) Int. Cl. G06F 3/038

(52) U.S. Cl. 345/212

(57) ABSTRACT

A monitoring and setting apparatus according to an embodiment of the present invention includes: an obtaining means for obtaining settings information of a monitored apparatus from the monitored apparatus; a display means for displaying the settings information of the monitored apparatus obtained by the obtaining means; an input means for changing the settings information of the monitored apparatus that has been displayed by the display means; and an instruction means for instructing the monitored apparatus to set the settings information of the monitored apparatus that has been changed by the input means. When the obtaining means obtains settings information of a plurality of monitored apparatuses, the display means divides a screen of the display means into a plurality of display regions and displays the settings information of the monitored apparatuses in the respective display regions, the input means can change the settings information of the monitored apparatuses for each monitored apparatus displayed in each display region, and the instruction means instructs each monitored apparatus whose settings information has been changed by the input means to set the changed settings information.

### BACKGROUND OF THE INVENTION

This application claims priority under 35 U.S.C. § 119(a) on Japanese Patent Application No. 2007-280494 filed in Japan on Oct. 29, 2007, the entire contents of which are herein incorporated by reference.

The present invention relates to a monitoring and setting apparatus capable of monitoring, adjusting and setting a plurality of monitored apparatuses, and a production system including such a monitoring and setting apparatus.

JP 2006-217493A discloses a technique for setting an adjustment value of an electronic apparatus, wherein in addition to a user adjustment mode that allows a user to set adjustment values, another adjustment mode is provided that allows an adjusting technician to set adjustment values, and identification information for identifying another adjustment mode, which is different from the user adjustment mode, is displayed on a screen when in the other adjustment mode to help adjusting the adjustment values.

However, according to the technique disclosed in JP 2006-217493A, when there are a plurality of electronic apparatuses, adjustment values are checked and set for each electronic apparatus, and thus even if the adjusting technician has made a mistake in adjustment value settings for an electronic apparatus, it is difficult and complicated to check and correct the adjustment values of the electronic apparatus.

### SUMMARY OF THE INVENTION

In view of the above circumstances, the present invention has been conceived to solve the problem encountered in the conventional technology, and it is an object of the present invention to provide a monitoring and setting apparatus that can collectively set a plurality of apparatuses and in which it is difficult to make a setting mistake in each apparatus, and a production system employing such a monitoring and setting apparatus.

In order to solve the above problem, a monitoring and setting apparatus of the present invention includes: an obtaining means for obtaining settings information of a monitored apparatus from the monitored apparatus; a display means for displaying the settings information of the monitored apparatus obtained by the obtaining means; an input means for changing the settings information of the monitored apparatus that has been displayed by the display means; and an instruction means for instructing the monitored apparatus to set the settings information of the monitored apparatus that has been changed by the input means, wherein when the obtaining means obtains settings information of a plurality of monitored apparatuses, the display means divides a screen of the display means into a plurality of display regions and displays the settings information of the monitored apparatuses in the respective display regions, the input means can change the settings information of the monitored apparatuses for each monitored apparatus displayed in each display region, and the instruction means instructs each monitored apparatus whose settings information has been changed by the input means to set the changed settings information.

The settings information of the monitored apparatus indicates an adjustment condition and any problem of the monitored apparatus.

The display means can selectively display any one of the settings information of the monitored apparatuses instead of displaying the settings information of the monitored apparatuses in the respective display regions.

The input means can set a standard value of the settings information of a monitored apparatus that has been displayed by the display means.

The input means can change the settings information of the monitored apparatus within a setting range defined based on the standard value of the settings information of the monitored apparatus.

The obtaining means obtains identification information of the monitored apparatus together with the settings information of the monitored apparatuses, and the display means displays the settings information and the identification information of the monitored apparatus obtained by the obtaining means.

The obtaining means and the instruction means perform the obtainment and instruction of the settings information of a monitored apparatus via a wireless LAN.

Furthermore, the monitored apparatus is an image forming apparatus.

A production system of the present invention includes the aforementioned monitoring and setting apparatus of the present invention.

According to the monitoring and setting apparatus thus configured, settings information of a plurality of monitored apparatuses is obtained, the settings information of the monitored apparatuses is displayed in the respective display regions of the screen of the display means, the settings information is changed for each monitored apparatus, and an instruction to set the changed settings information is provided to the monitored apparatus. Accordingly, it is possible to collectively set settings information of a plurality of monitored apparatuses at the monitoring and setting apparatus side, and thus it is difficult to make a setting mistake in the monitored apparatuses.

For example, the settings information of each monitored apparatus indicates an adjustment condition and any problem of the monitored apparatus. In this case, it is possible to change the adjustment condition of the monitored apparatus or check the problem at the monitoring and setting apparatus side.

Furthermore, instead of displaying the settings information of the monitored apparatuses in the respective display regions, any one of the settings information of the monitored apparatuses can be selectively displayed.

In addition, because it is possible to set a standard value of the settings information of the monitored apparatus or change the settings information within a setting range defined based on the standard value of the settings information of the monitored apparatus, the adjustment of the settings information can be easily performed using the standard value as a reference.

Because the identification information of the monitored apparatus is obtained and displayed together with the settings information of the monitored apparatus, the settings information of a plurality of monitored apparatuses can be identified by the respective identification information.

For example, the obtainment and instruction of the settings information of the monitored apparatus can be performed via a wireless LAN.

For example, the monitored apparatus is an image forming apparatus. As the image forming apparatus, there is an electrophotographic image forming apparatus. In the electrophotographic image forming apparatus, it is necessary to set a charge voltage at which the photosensitive body is charged, a developing bias of the development apparatus, a transfer voltage, a fixing temperature and the like. In the present invention, these are collectively defined as settings information, whereby the charge voltage, developing bias, transfer voltage and fixing temperature of a plurality of monitored apparatuses can be set collectively at the monitoring and setting apparatus side, and thus image forming failures resulting from a setting mistake in the image forming apparatuses can be avoided.

A production system of the present invention includes the aforementioned monitoring and setting apparatus of the present invention. Because a plurality of apparatuses are used in the production system, by using these apparatuses as monitored apparatuses with the monitoring and setting apparatus of the present invention, collective management of the monitored apparatuses can be achieved.

### BRIEF DESCRIPTION OF THE DRAWINGS

FIG. 1 is a block diagram schematically illustrating a monitoring and setting apparatus according to an embodiment of the present invention.

FIG. 2 is a perspective view illustrating the monitoring and setting apparatus of FIG. 1.

FIG. 3 is a block diagram illustrating a production system in which the monitoring and setting apparatus of FIG. 1 is employed.

FIG. 4 is a plan view illustrating a touch panel of the monitoring and setting apparatus of FIG. 1

FIG. 5 is a diagram illustrating an example of a divided screen of a display apparatus of the monitoring and setting apparatus of FIG. 1

FIG. 6 is a diagram illustrating an example of a screen displayed in a simulation mode of the monitoring and setting apparatus of FIG. 1.

FIG. 7 is a diagram illustrating an example of a screen for setting an adjustment value of the monitoring and setting apparatus of FIG. 1.

### DESCRIPTION OF THE PREFERRED EMBODIMENT

Hereinafter, an embodiment of the present invention will be described with reference to the accompanying drawings.

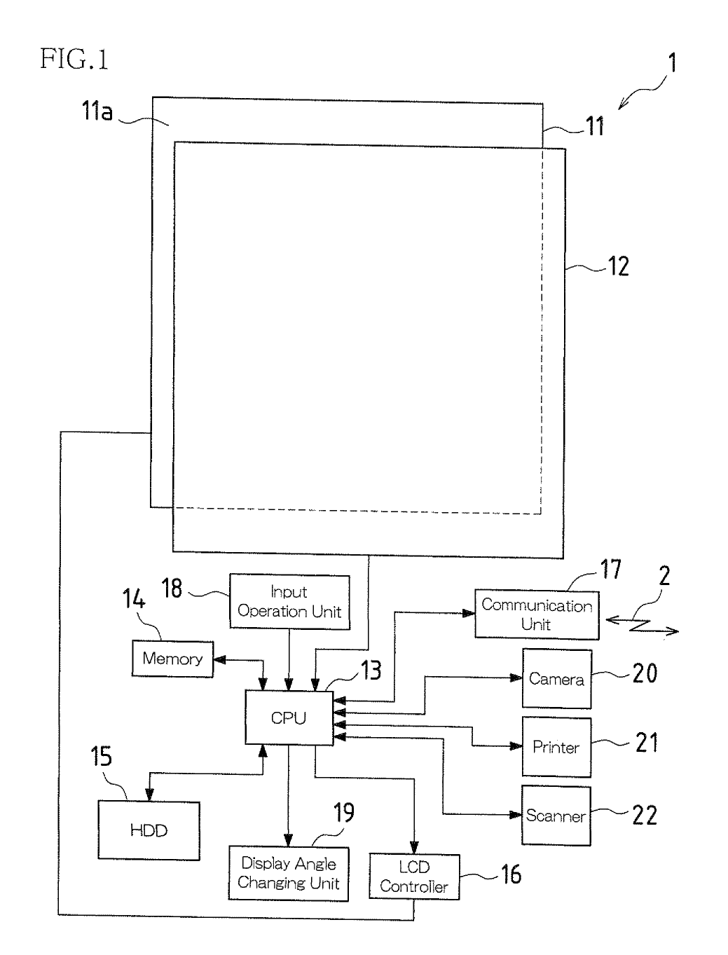

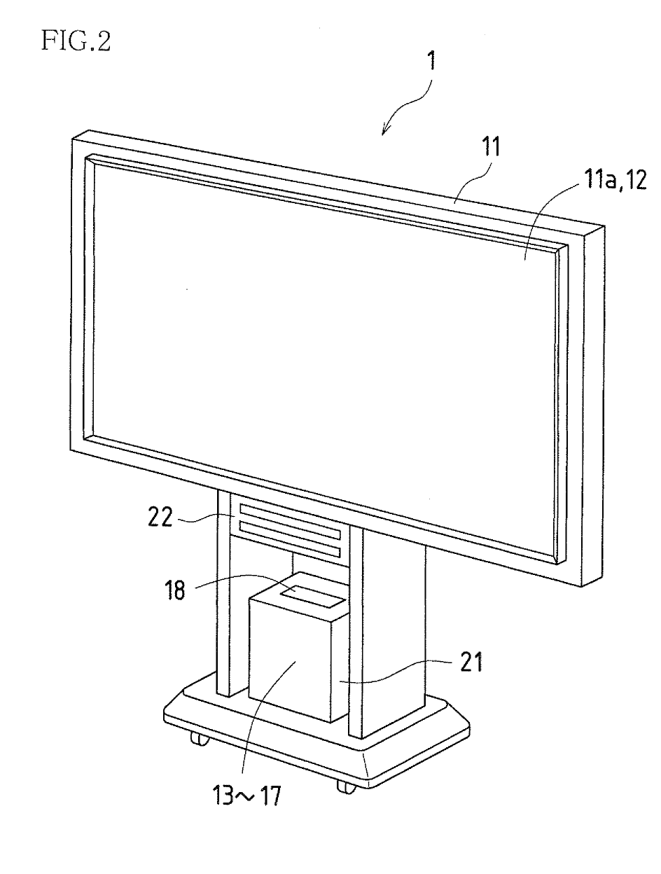

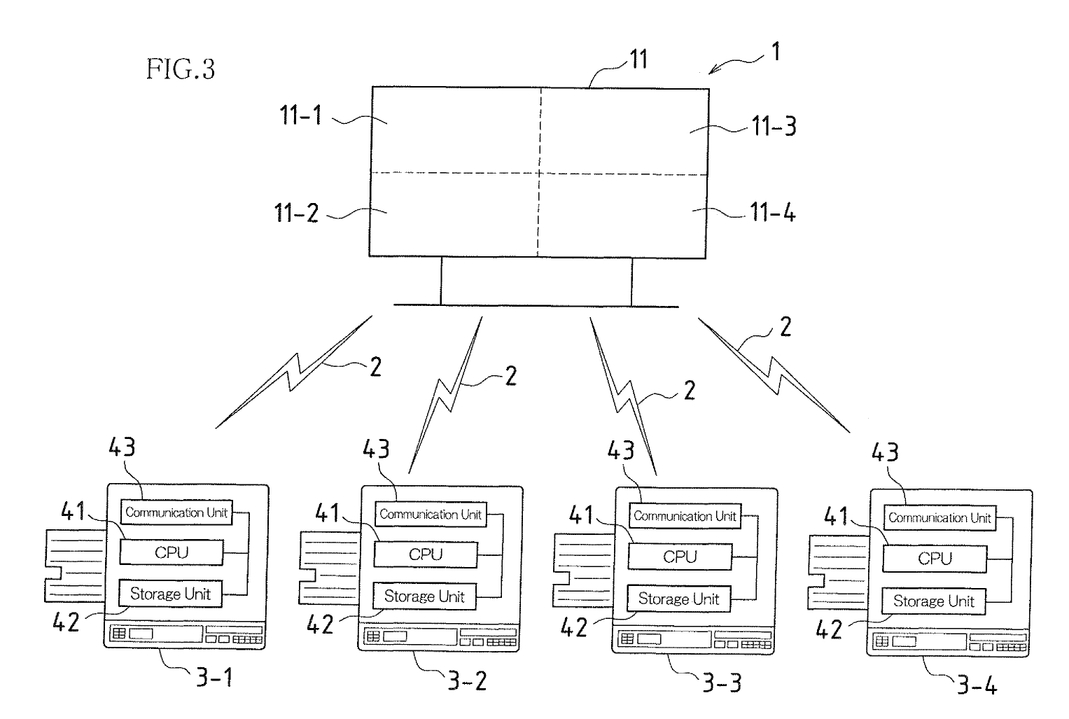

FIG. 1 is a block diagram schematically illustrating a monitoring and setting apparatus according to an embodiment of the present invention. FIG. 2 is a perspective view of the monitoring and setting apparatus of the present embodiment. FIG. 3 is a block diagram illustrating a production system in which the monitoring and setting apparatus of the present embodiment is employed.

As shown in FIG. 3, the monitoring and setting apparatus 1 of the present embodiment is connected to a plurality of image forming apparatuses 3-1 to 3-4 via a wireless LAN 2, so that the image forming apparatuses 3-1 to 3-4 can be monitored and managed. In the present embodiment, as an example, four image forming apparatuses 3-1 to 3-4 are connected, but the monitoring and setting apparatus 1 can be connected to up to a maximum of 16 image forming apparatuses via the wireless LAN 2 to monitor and manage the image forming apparatuses.

As shown in FIGS. 1 and 2, the monitoring and setting apparatus 1 of the present embodiment includes a display apparatus 11 such as a large liquid crystal display apparatus, a touch panel 12 superimposed on a screen 11a of the display apparatus 11, a CPU 13 that performs overall control of the monitoring and setting apparatus 1, a memory 14 used as a working area for the CPU 13, a hard disk drive 15 that stores various data, programs, etc., an LCD controller 16 that performs display control of the display apparatus 11, a communication unit 17 that performs data communication via the wireless LAN 2, an input operation unit 18 that is operated to input data or the like, a display angle changing unit 19 for changing the orientation of the display apparatus 11, a camera 20, a printer 21, and a scanner 22.

The communication unit 17 has a maximum of 16 input/output ports, allowing the monitoring and setting apparatus 1 to wirelessly connect to a maximum of 16 image forming apparatuses via the wireless LAN 2 as described above.

The input operation unit 18 can be a keyboard, mouse or the like, with which data or the like is inputted by an input operation and is transmitted to the CPU 13.

The display angle changing unit 19 drives the display apparatus 11 in the up, down, right and left directions to change the orientation of the screen 11a. Upon receiving an instruction to change the orientation of the screen 11a through an input operation of the input operation unit IS, the CPU 13 controls the display angle changing unit 19 to drive the display apparatus 11 in the up, down, right or left direction so as to move the screen 11a in the direction instructed by the input operation.

The printer 21 prints images and the like on recording paper. When the camera 20 captures an image, or when the scanner 22 scans an image or the like from an original document, the image or the like is inputted to the printer 21 through the CPU 13, and is printed by the printer 21.

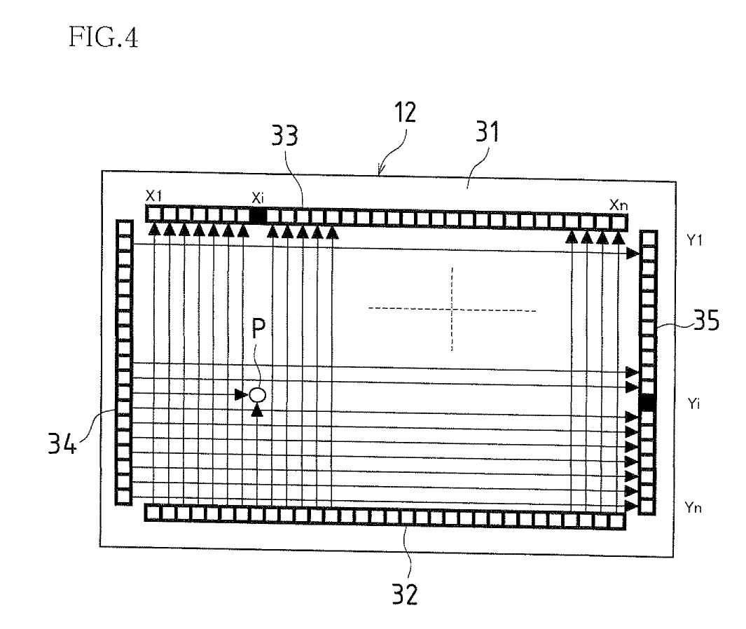

The touch panel 12 is a flat plate panel having a light transmitting property, so that the screen 11a of the display apparatus 11 can be seen through the touch panel 12. As shown in FIG. 4, an LED array 32 and a phototransistor array 33 are disposed in opposing two sides in the x direction of a light transmitting plate 31 such as a glass plate, and an LED array 34 and a phototransistor array 35 are disposed in opposing two sides in the y direction of a light transmitting plate 31. In the LED array and the phototransistor array, LED elements or phototransistor elements are disposed at a pitch of 0.5 mm. In this touch panel 12, a plurality of light beams are emitted from the LED array 32 in the x direction to be incident upon the phototransistor array 33. Likewise, a plurality of light beams are emitted from an LED array 34 in the y direction to be incident upon a phototransistor array 35. In this state, when the tip of a pen is made to touch a position P on the touch panel 12, some of the plurality of light beams emitted from the LED array 32 in the x direction are blocked by the tip of the pen, and this blocked position in the x direction is detected by the phototransistor array 33 as an x coordinate. At the same time, some of the plurality of light beams emitted from the LED array 34 in the y direction are blocked by the tip of the pen, and this blocked position in the y direction is detected by the phototransistor array 35 as a y coordinate. Consequently, the position P at which the tip of the pen is located is detected as xy coordinates.

The touch panel 12 may be of optical type, or another type such as a resistive film type or pressure-sensitive type.

The CPU 13 inputs the xy coordinates of the tip of the pen detected by the touch panel 12 as a point on the screen 11a of the display apparatus 1. When a letter, shape or the like is written by the tip of the pen, the CPU 13 inputs the xy coordinates of the tip of the pen detected by the touch panel 12 each time to obtain a trail along which the xy coordinates of the tip of the pen moved, and then stores the trail, or in other words, the letter, shape or the like in the memory 14 as an object. The CPU 13 reads out the object from the memory 14, and displays the object, that is, the letter, shape or the like, on the screen 11a of the display apparatus 11.

The display of the object on the screen 11a of the display apparatus 11 is performed at the same time as the object is being drawn on the touch panel 12, in other words, the object is displayed in real time. In this case, it is possible to check the object on the screen 11a of the display apparatus 11 while drawing it with the pen.

Furthermore, even if the object on the screen 11a of the display apparatus 11 is erased, upon receiving an instruction to display the object again through an input operation of the input operation unit 18, the CPU 13 reads out the object from the memory 14 and displays the object again on the screen 11a of the display apparatus 11.

In FIG. 3, the image forming apparatuses 3-1 to 3-4 are shown, but the number of image forming apparatuses can be increased to a maximum of 16. In this case, each image forming apparatus performs printing on recording paper. Accordingly, it can be said that the production system shown in FIG. 3 is also a printing system.

The image forming apparatuses 3-1 to 3-4 are of electrophotographic type. In an electrophotographic type, an electrostatic latent image is formed on a photosensitive drum surface. The electrostatic latent image formed on the photosensitive drum surface is developed with toner to form a toner image on the photosensitive drum surface. The toner image is transferred from the photosensitive drum to recording paper. The recording paper is heated and pressed to fix the toner image on the recording paper.

The image forming apparatuses 3-1 to 3-4 each include a CPU 41 that performs overall control of the image forming apparatus, a storage unit 42, and a communication unit 43 that performs data communication with the monitoring and setting apparatus 1 via the wireless LAN 2.

For such an electrophotographic image forming apparatus, it is necessary to set adjustment values such as a charge voltage at which the photosensitive body is charged, a developing bias of the development apparatus, a transfer voltage and a fixing temperature.

If the adjustment values, such as the charge voltage, developing bias, transfer voltage and fixing temperature, are managed and set for each image forming apparatus, it will be difficult and complicated to check and correct the adjustment values of the image forming apparatus regardless of a setting mistake made by the adjusting technician.

In light of this, in the monitoring and setting apparatus 1 of the present embodiment, the adjustment values such as the charge voltage, developing bias, transfer voltage and fixing temperature of an image forming apparatus are defined as settings information, and the monitoring and setting apparatus 1 is configured such that the settings information of each of the image forming apparatuses 3-1 to 3-4 is obtained through data communication with the image forming apparatuses 3-1 to 3-4 via the wireless LAN 2, and their settings information is displayed on the screen 11a of the display apparatus 11 so that the settings information can be checked. It is also configured such that the settings information displayed on the screen 11a of the display apparatus 11 can be changed for each of the image forming apparatuses 3-1 to 3-4 through an input operation of the input operation unit 18, the changed settings information is transmitted back to the image forming apparatus via the wireless LAN 2, and the adjustment values, such as the charge voltage, developing bias, transfer voltage and fixing temperature, are updated in accordance with the changed setting information. Because this enables a collective setting of the adjustment values of the image forming apparatuses 3-1 to 3-4, it is difficult to make a setting mistake in each image forming apparatus, and thus image forming failures resulting from a setting mistake in an image forming apparatus can be prevented.

A procedure for managing and setting the adjustment values of the image forming apparatuses 3-1 to 3-4 performed by the monitoring and setting apparatus 1 will be described next in detail.

In the monitoring and setting apparatus 1, upon receiving an instruction to collect settings information of each of the image forming apparatuses 3-1 to 3-4 through an input operation of the input operation unit 18 by the adjusting technician, the CPU 13 instructs the image forming apparatuses 3-1 to 3-4 to send their settings information via the wireless IAN 2.

In each of the image forming apparatuses 3-1 to 3-4, the instruction to send their settings information is received by the communication unit 43, and is inputted to the CPU 41. Upon receiving an input of the instruction, the CPU 41 collects adjustment values such as charge voltage, developing bias, transfer voltage and fixing temperature. The CPU 41 also reads out the identification number of the image forming apparatus (model name, manufacturing number, etc.) from the storage unit 42, and transmits settings information indicative of the adjustment values and the identification number to the monitoring and setting apparatus 1 via the wireless LAN 2. Through this, the settings information of each of the image forming apparatuses 3-1 to 3-4 are transmitted to the monitoring and setting apparatus 1.

In the monitoring and setting apparatus 1, the settings information of each of the image forming apparatuses 3-1 to 3-4 that is indicative of the adjustment values, such as charge voltage, developing bias, transfer voltage and fixing temperature, and the identification number is received by the communication unit 17, and is inputted to the CPU 13. Upon receiving an input of the settings information of each of the image forming apparatuses 3-1 to 3-4, the CPU 13 extracts the adjustment values, such as charge voltage, developing bias, transfer voltage and fixing temperature, and the identification number from the settings information of each of the image forming apparatuses 3-1 to 3-4, associates the adjustment values with the identification number, and stores them on the hard disk drive 15.

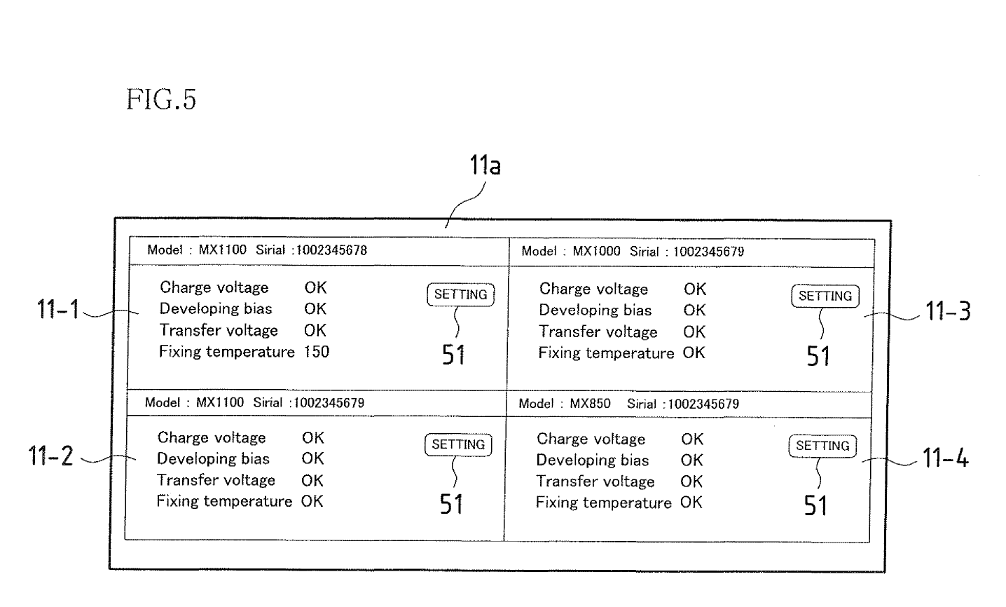

Because there are four image forming apparatuses 3-1 to 3-4, the CPU 13 divides the screen 11a of the display apparatus 11 into four display regions 11-1, 11-2, 11-3 and 11-4, and displays the adjustment values and the identification number of each of the image forming apparatuses 3-1 to 3-4 on the respective display regions as shown in FIG. 5.

In the present embodiment, the charge voltage, developing bias, transfer voltage, fixing temperature and identification number of each image forming apparatus are displayed in each display region, and an adjustment instruction button 51 is also displayed. For the charge voltage, developing bias, transfer voltage and fixing temperature, a standard value or a setting range defined based on its standard value is predefined. If the adjustment value is equal to its standard value, or falls within its setting range, “OK” is displayed, indicating this condition. Conversely, if the adjustment value is not equal to its standard value, or does not fall within its setting range, the adjustment value is displayed. For example, referring to the display region 11-1, “Model: MX100 Serial: 1002345678” is displayed as the identification number. In “Charge voltage”, “OK” is displayed, indicating that the charge voltage is equal to its standard value or falls within its setting range. In “Developing bias”, “OK” is displayed, indicating that the developing bias is equal to its standard value or falls within its setting range. In “Transfer voltage”, “OK” is displayed, indicating that the transfer voltage is equal to its standard value or falls within its setting range. In “Fixing temperature”, 150(° C.) is displayed because the fixing temperature is not equal to its standard value or does not fall within its setting range.

With a glance of the screen 11a of the display apparatus 11, the charge voltage, developing bias, transfer voltage and fixing temperature of each of the image forming apparatuses 3-1 to 3-4 can be checked collectively, and variations of the adjustment values and a tendency thereof can be easily understood through comparisons among the image forming apparatuses 3-1 to 3-4.

Here, the screen 11a of the display apparatus 11 is divided into four display regions 11-1 to 11-4. If the number of image forming apparatuses changes, the same number of display regions as the image forming apparatuses can be formed by dividing the screen 11a of the display apparatus 11 into the same number of regions. If there are many image forming apparatuses, the settings information and identification number of the image forming apparatuses may be displayed over a plurality of pages, each page containing content as displayed on the screen 11a. For example, if there are 18 image forming apparatuses, the settings information and identification number of the 18 image forming apparatuses are spread over 5 pages, which can be scrolled page by page through an input operation of the input operation unit 18. On the first to fourth pages, the settings information and identification number of four image forming apparatuses are displayed in four display regions. On the fifth page, the settings information and identification number of two image forming apparatuses are displayed in two display regions. It is also possible to configure such that the number of regions, into which the screen 11a of the display apparatus 11 is divided, is selected through an input operation of the input operation unit 18. For example, the number of regions into which the screen 11a of the display apparatus 11 is divided can be selected from any one of 1, 2, 4, 8 and 16, and the screen 11a is divided into the instructed number of regions. If 1 is selected, the screen ha is not divided, and the settings information and identification number of a single image forming apparatus are displayed on the entire screen 11a.

In the state as shown in FIG. 5 where the adjustment values and identification value of the image forming apparatuses 3-1 to 3-4 are displayed in the respective display regions 11-1 to 11-4 on the screen 11a of the display apparatus 11, only the fixing temperature 150(° C.) of the display region 11-1 is different from that of other display regions, and thus it can be seen that the fixing temperature of the image forming apparatus 3-1 has been improperly set.

Subsequently, the fixing temperature of the image forming apparatus 3-1 displayed on the display region 11-1 is adjusted and changed in the following procedure.

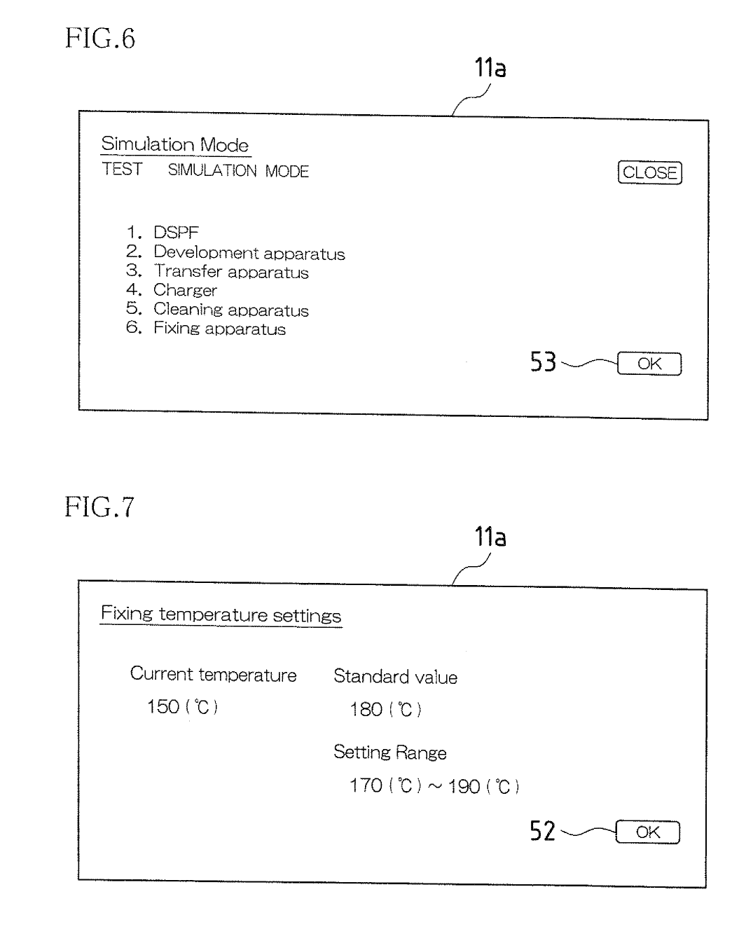

First, the adjusting technician performs an input operation of the input operation unit 18 to select an adjustment instruction button 51 of the display region 11-1. Upon selection of the adjustment instruction button 51 of the display region 11-1, the CPU 13 sets a simulation mode for changing the adjustment values of the image forming apparatus 3-1, and updates the screen 11a of FIG. 5 to a simulation mode screen 11a as shown in FIG. 6. On the screen 11a shown in FIG. 6, the following six items are displayed “1. DSPF (double-sided scan paper feeder)”, “2. Development apparatus”, “3. Transfer apparatus”, “4. Charger”, “5. Cleaning apparatus” and “6. Fixing apparatus”, one of which is selected by an input operation of the input operation unit 18. Specifically, when it is necessary to change the adjustment value of DSPF, “1. DSPF” is selected. When it is necessary to change the developing bias of the development apparatus, “2. Development apparatus” is selected. When it is necessary to change the transfer voltage of the transfer apparatus, “3. Transfer apparatus” is selected. When it is necessary to change the charge voltage of the charger, “4. Charger” is selected. When it is necessary to change the adjustment value of the cleaning apparatus, “5. Cleaning apparatus” is selected. When it is necessary to change the fixing temperature of the fixing apparatus, “6. Fixing apparatus” is selected.

Here, because it is necessary to change the fixing temperature of the image forming apparatus 3-1, “6. Fixing apparatus” is selected through an input operation of the input operation unit 18. In response to this, the CPU 13 displays a screen 11a for making fixing temperature settings as shown in FIG. 7, instead of the screen 11a shown in FIG. 6. On the screen 11a of FIG. 7, the currently set fixing temperature 150(° C.), the standard value 180(° C.) for the fixing temperature and the setting range (170° C. to 190° C.) are displayed, so that the current fixing temperature 150(° C.) can be changed to, for example, 180(° C.) through an input operation of the input operation unit 18 while referring to the standard value 180(° C.) and the setting range (170° C. to 190° C.). At this time, the CPU 13 may be configured to issue an instruction to forcefully change the current fixing temperature 150(° C.) to the standard value 180(° C.) if the temperature instructed through an input operation of the input operation unit 18 falls outside the setting range.

Afterward, if an OK button 52 is selected on the screen 11a shown in FIG. 7 through an input operation of the input operation unit 18, in response to this, the CPU 13 transmits the settings information indicative of the changed fixing temperature 180(° C.) and the identification number of the image forming apparatus 3-1 via the wireless LAN 2.

In the image forming apparatus 3-1, the settings information is received by the communication unit 43, and is inputted to the CPU 41. Upon receiving an input of the settings information, the CPU 41 fetches the fixing temperature 180(° C.) indicated by the settings information as the fixing temperature of its own image forming apparatus 3-1 since the settings information includes the identification number of the image forming apparatus 3-1, and performs control to change the fixing temperature of the fixing apparatus to this fixing temperature 180(° C.). Through this, the fixing temperature of the fixing apparatus of the image forming apparatus 3-1 is updated from 150(° C.) to 180(° C.), correcting the setting mistake of the fixing temperature.

Incidentally, if the settings information is received by another image forming apparatus, because the identification information indicated by the settings information is not that of the image forming apparatus, the settings information will not be entered and the fixing temperature indicated by the settings information will not be set.

Upon selection of the OK button 52 on the screen 11a of FIG. 7, the CPU 13 changes the screen 11a of FIG. 7 back to the screen 11a of FIG. 6. On the screen 11a of FIG. 6, if an OK button 53 is selected through an input operation of the input operation unit 18, in response to this, the CPU 13 changes the screen 11a of FIG. 6 back to the original screen 11a shown in FIG. 5.

Afterward, in the same procedure as described above, if the adjustment instruction button 51 of a display region is selected through an input operation of the input operation unit 18, a simulation mode for changing the adjustment values of the image forming apparatus that are displayed in the display region is set, and the screen 11a of FIG. 6 is displayed. If any one of the six items is selected, the screen 11a for setting the adjustment value of the selected item is displayed. After the adjustment value is changed on the screen 11a and the OK button 52 is selected, the changed adjustment value is transmitted together with the identification number of the image forming apparatus and is received by that image forming apparatus, and the corresponding adjustment value is changed to the received adjustment value.

If an end instruction is entered through an input operation of the input operation unit 18 while the screen 11a of FIG. 5 is displayed, the monitoring of the image forming apparatuses by the monitoring and setting apparatus 1 is terminated.

The present invention is not limited to the above-described embodiment, and can be modified in various ways. For example, the charge voltage, developing bias, transfer voltage and fixing temperature of an image forming apparatus are used as the settings information, but it is also possible to use other adjustment values such as the rotation speed of a polygon mirror, a problem such as a paper jam, etc. Furthermore, the monitored apparatuses may be apparatuses other than the image forming apparatus. In addition, the display form displayed on the screen may be changed as appropriate.

The present invention may be embodied in various other forms without departing from the gist or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. A monitoring and setting apparatus comprising:
an obtaining means for obtaining settings information of a monitored apparatus from the monitored apparatus;
a display means for displaying the settings information of the monitored apparatus obtained by the obtaining means;
an input means for changing the settings information of the monitored apparatus that has been displayed by the display means; and an instruction means for instructing the monitored apparatus to set the settings information of the monitored apparatus that has been changed by the input means, wherein when the obtaining means obtains settings information of a plurality of monitored apparatuses, the display means divides a screen of the display means into a plurality of display regions and displays the settings information of the monitored apparatuses in the respective display regions, the input means can change the settings information of the monitored apparatuses for each monitored apparatus displayed in each display region, and the instruction means instructs each monitored apparatus whose settings information has been changed by the input means to set the changed settings information.

2. The monitoring and setting apparatus according to claim 1, wherein the settings information of the monitored apparatus indicates an adjustment condition and any problem of the monitored apparatus.

3. The monitoring and setting apparatus according to claim 1, wherein the display means can selectively display any one of the settings information of the monitored apparatuses instead of displaying the settings information of the monitored apparatuses in the respective display regions.

4. The monitoring and setting apparatus according to claim 1, wherein the input means can set a standard value of the settings information of a monitored apparatus that has been displayed by the display means.

5. The monitoring and setting apparatus according to claim 4, wherein the input means can change the settings information of the monitored apparatus within a setting range defined based on the standard value of the settings information of the monitored apparatus.

6. The monitoring and setting apparatus according to claim 1, wherein the obtaining means obtains identification information of the monitored apparatus together with the settings information of the monitored apparatus, and the display means displays the settings information and the identification information of the monitored apparatus obtained by the obtaining means.

7. The monitoring and setting apparatus according to claim 1, wherein the obtaining means and the instruction means perform the obtainment and instruction of the settings information of the monitored apparatus via a wireless LAN.

8. The monitoring and setting apparatus according to claim 1, wherein the monitored apparatus is an image forming apparatus.

9. A production system comprising the monitoring and setting apparatus according to claim 1.
